(19) United States
(12) Patent Application Publication
(10) Pub. No.: US 2026/0273446 A1
(43) Pub. Date: Sep. 17, 2026

(54) COALESCING SEPARATOR INSERT, COALESCING SEPARATOR, AND PROCESS FOR MANUFACTURING A COALESCING SEPARATOR INSERT

(71) Applicant: MANN+HUMMEL GmbH, Ludwigsburg (DE)

(72) Inventors: Thomas GREIN, Eggenstein-Leopoldshafen (DE); Frank VOGT, Hanhofen (DE)

(21) Appl. No.: 19/466,650

(22) Filed: Feb. 2, 2026

Related U.S. Application Data
(63) Continuation of application No. PCT/EP2024/071258, filed on Jul. 26, 2024.

(30) Foreign Application Priority Data
Aug. 11, 2023 (DE) 10 2023 121 510.8

(51) Int. Cl. B01D 46/00; B01D 46/24; B01D 46/64

(52) U.S. Cl. CPC B01D 46/0031; B01D 46/2411; B01D 46/64; B01D 2275/105

(57) ABSTRACT

A coalescing separator insert for separating liquid from a gas flow includes a first coalescing separator body with a first coalescing separator medium arranged around a support tube supporting the first coalescing separator body and a second coalescing separator body with a second coalescing separator medium arranged concentrically in a gas flow direction downstream of the first coalescing separator body. The second coalescing separator medium spaced apart radially from the at least one first coalescing separator body by a drainage space includes at least two coalescing separator medium layers arranged concentrically to the first coalescing separator body around a second support tube supporting the second coalescing separator body. The coalescing separator medium layers each have at least two separate coalescing separator medium layer elements connected to each other at overlapping lateral end regions. A coalescing separator with the coalescing separator insert and a method of manufacturing the coalescing separator insert.

### CROSS-REFERENCE TO RELATED APPLICATIONS

This application is a continuation application of international application No. PCT/EP2024/071258 having an international filing date of Jul. 26, 2024, and designating the United States, the international application claiming a priority date of Aug. 11, 2023, based on prior filed German patent application No. 10 2023 121 510.8, the entire content of the aforesaid applications being incorporated herein by reference to the fullest extent permissible.

### BACKGROUND

The invention concerns a coalescing separator insert for separating liquid, for example liquid drops, for example, oil, for example, oil drops, from a gas flow, for example from an air flow, for example, from a compressed air flow, wherein the gas flow, in a position of use of the coalescing separator insert, flows through the coalescing separator insert from the exterior to the interior or from the interior to the exterior, including:
at least one first coalescing separator body acting according to the coalescence principle, including at least one first coalescing separator medium, which is configured to separate liquid from the gas flow by means of the coalescence principle and which is arranged around an air-permeable, cylindrical first support tube configured to support the first coalescing separator body, and
at least one further coalescing separator body including at least one further coalescing separator medium, which is configured to separate liquid from the gas flow by means of the coalescence principle and is arranged in a flow direction of the gas flow downstream of the first coalescing separator body, which is arranged concentrically to the first coalescing separator medium and is spaced apart radially by a drainage space from the first coalescing separator body.

The invention further concerns a coalescing separator including a coalescing separator insert of the aforementioned kind and a pressure-stable housing for receiving the coalescing separator insert.

The invention concerns furthermore a process for manufacturing a coalescing separator insert for cleaning a gas flow which, in position of use of the coalescing separator insert, flows from the exterior to the interior or from the interior to the exterior through the coalescing separator insert, wherein:
(I) for providing a first coalescing separator body, at least one first coalescing separator medium configured to separate oil from air by means of the coalescence principle is arranged around a cylindrical, air-permeable first support tube configured to support the first coalescing separator body,
(ii) for providing a further coalescing separator body, at least one further coalescing separator medium configured to separate oil from air by means of the coalescing principle is concentrically arranged in relation to the first coalescing separator medium, for example, is arranged around a cylindrical air-permeable further support tube configured to support the further coalescing separator body,
(iii) the further coalescing separator body is arranged concentrically to the first coalescing separator body such that the further coalescing separator body is radially spaced apart by a drainage space from the first coalescing separator body.

Air oil separator elements are known from the printed publication EP 1 738 816 B1, for example. The air to be purified flows from the exterior to the interior through the air oil separator element, wherein a multilayer main separator acting in accordance with the coalescence principle separates and coalesces oil drops from the air flowing through. The secondary aerosol exiting from the main separator flows subsequently through a further coalescing separator body, a post separator, wherein the enlarged coalesced drops are separated and drained following the force of gravity.

For manufacturing the post separator, usually heavy nonwovens, for example, staple fiber nonwovens, for example carded materials, are used. As shown in the drawing figures of EP 1 738 816 B1, the post separator is embodied as a single layer. The nonwoven layer of the post separator embodied as a single layer is formed by sewing or welding to a hose in a conventional manner and subsequently pulled over the support tube.

It is the object of the invention to further develop a coalescing separator insert of the aforementioned kind, a coalescing separator of the aforementioned kind, and a process of the aforementioned kind in such a way that the coalescing separator insert is manufactured easily and inexpensively, while still achieving a high degree of separation. Primarily, a space-saving automated manufacture of the post separator is to be provided.

### SUMMARY

This object is solved by a coalescing separator insert of the aforementioned kind wherein the further coalescing separator body includes at least two coalescing separator medium layers which are arranged concentrically to the first coalescing separator medium, respectively, for example, are concentrically arranged around a cylindrical further support tube configured to support the further coalescing separator body.

This object is further solved by a coalescing separator including a coalescing separator insert according to the invention and a pressure-stable housing for receiving the coalescing separator insert, wherein the pressure-stable housing includes a cup-shaped housing body, a cover configured to close the open end face of the housing body, a raw gas inlet configured to supply raw gas to the coalescing separator and connectable to a raw gas feed of a connector element of a machine, and a clean gas outlet configured to discharge clean gas and connectable to a clean gas discharge of the connector element.

This object is further solved by a process of the aforementioned kind wherein in providing the further coalescing separator body as described in step (ii), at least two coalescing separator medium layers are arranged concentrically to the first coalescing separator medium, respectively, for example, in that, in arranging the further coalescing separator body at the further support tube as described in step (ii), at least two coalescing separator medium layers are arranged concentrically around the further support tube, respectively.

Exemplary embodiments and expedient further developments of the present invention are described in the following description and the accompanying drawing figures.

Thus, the present invention is based on the further coalescing separator body, embodied for example as a post separator, including at least two coalescing separator medium layers, for example annular in cross section, which are arranged concentrically to the first coalescing separator medium, respectively. For example, the coalescing separator medium layers may be arranged concentrically around a cylindrical further support tube, embodied for supporting the further coalescing separator body. The further support tube is optional. In principle, the structure of the multilayer coalescing separator body may function also without an additional or further support tube. The further support tube is a cylindrical hollow body which, for example, may be manufactured from metal, from plastic material, or from fabric.

In other words, the further coalescing separator body includes at least one further filter medium, which is arranged in operative form, optionally tailored, stacked, wound, folded etc., and provides at least two coalescing separator medium layers. The coalescing separator medium layers are arranged sequentially or overlappingly relative to each other in a flow direction of the gas flow.

In the present invention, the entire further coalescing separator body is thus constructed of multiple layers. This multilayer construction enables a simple adaptation of the further coalescing separator body to different dimension demands and separation demands.

An advantage of the present invention is thus that the number of layers of the further coalescing separator body may be selected depending on the requirement in regard to its degree of separation. This makes it possible to manufacture different separator variants with the same coalescing separator material. In contrast thereto, in case of known single-layer post separators, a specific individually adapted coalescing separator material with a defined material thickness must be used, respectively, for manufacturing different separator variants.

As a material for the further coalescing separator body, a known coalescing separator medium material for post separators may be arranged in multiple layers, for example, laid around the further support tube. This is advantageous primarily when higher demands are made in regard to the degree of separation of the post separator.

Furthermore, a multilayer construction of the post separator enables its manufacture from coalescing separator media, for example, from nonwovens, which, in comparison to the known single-layer post separator media are embodied more lightweight and are offered in large quantities and inexpensively for standard applications. For example, the further coalescing separator body may be formed from at least one coalescing separator medium, for example, a nonwoven, with a grammage of up to 300 grams per square meter (g/m5), for example, of 25 to 250 g/m5, for example of 50 to 200 g/m5.

The manufacture of the further coalescing separator body from a plurality of relatively thin coalescing separator medium layers in place of a thick layer has the further advantage that the connection seams take up less space radially. This makes it possible to fill the saved space with further coalescing separator medium layers and to increase in this way the degree of separation. As a material for the further coalescing separator body, for example, staple fiber nonwoven and/or spunbond nonwoven and/or meltblown nonwoven may be used. Spunbond nonwovens are usually thin. The multilayer construction enables the formation of thick layers. Staple fiber nonwovens provide relatively thick inexpensive layers, even in case of few layers. Furthermore, the material of the further coalescing separator body may include, at least mainly, polyester fibers, polyamide fibers or glass fibers or mixtures thereof.

A thickness of all coalescing separator medium layers of the further coalescing separator body of an embodiment of the present invention, for example, determined according to DIN EN ISO 9073-2, i.e., at a contact pressure of 0.5 kPa, amounts to a total of more than two millimeters (mm), for example more than 2.5 mm, for example, 4 mm to 10 mm.

A space-saving and cost-efficient possibility of manufacturing the further coalescing separator body of the coalescing separator insert according to the invention resides thus in:
concentrically arranging at least two separate coalescing separator medium layer elements, for example coalescing separator medium web elements, which are manufactured with oversize in circumferential direction, in such a way, for example, arranging around, for example laying around, the further support tube in such a way, that their respective lateral end regions arranged perpendicularly to the end face of the coalescing separator insert are arranged overlappingly relative to each other, and
subsequently connecting to each other the overlappingly arranged lateral end regions by means of a connection seam extending along the longitudinal axis of the further coalescing separator body.

In this context, the web elements of each coalescing separator medium layer are arranged concentrically, for example, semi-circularly, in relation to the first coalescing separator medium in such a way that the coalescing separator medium layer created by them forms a closed cylinder wall surface. For example, the web elements of each coalescing separator medium layer may be arranged in such a way around the further support tube that the coalescing separator medium layer created by them surrounds completely the further support tube in circumferential direction.

In comparison to the prior manufacture of a post separator in which the latter is formed to a hose, fixed, and subsequently pulled over the further support tube, the manufacture of the further coalescing separator body according to the present invention, in which the further coalescing separator medium layer elements, for example, are laid around the further support tube and overlapping lateral end regions are fixed relative to each other, is a significantly less expensive type of manufacture. In addition, the further coalescing separator body manufactured according to the present invention is easily adaptable to various requirements in regard to the degree of separation.

In addition, the construction of the coalescing separator medium layers from a plurality of elements enables a further saving of the space occupied by the connection seam. For example, several, for example, two small connection seams require radially less space than a thick seam. The gained space may be used for providing further coalescing separator medium layers sequentially arranged in flow direction which increases the degree of separation. Due to the multilayer feature of the coalescing separator medium layers sequentially arranged in flow direction of the gas flow as well as due to the construction of the individual coalescing separator medium layers from at least two elements, in the coalescing separator insert of the present invention it is thus possible to achieve a higher degree of separation within the same space in comparison to a known single-layer post separator.

In an embodiment of the present invention, for manufacturing the further coalescing separator body, at least two at least two-layer coalescing separator medium layer elements are placed, for example, from opposite sides, around a cylinder-shaped hollow space or around the further support tube and connected to each other, for example fused to each other, at overlappingly arranged lateral end regions of the coalescing separator medium layer elements. In other words, a multilayer further coalescing separator body is created by joining, for example by fusing, four or more coalescing separator medium layer elements, for example coalescing separator medium web elements. This makes it possible to define and to select, depending on the requirements in regard to the degree of separation of the further coalescing separator body, the number of layers of the further coalescing separator body, for example, of the post separator, during its manufacture. In this way, the material for the further coalescing separator body may be held in stock and different separator variants may be manufactured with the same coalescing separator medium material. In contrast thereto, for the manufacture of a known single-layer post separator a specific coalescing separator medium material with a specific defined thickness must be used for each separator variant. In addition, a cost-efficient combination of at least two layers of different filter media is made possible.

In order to enable a cost-efficient storage of materials for forming the coalescing separator body, the material of the coalescing separator medium layers includes a uniform mechanical structure and is manufactured of the same coalescing separator medium.

However, the plies or layers of the coalescing separator body may also be manufactured from one or several different materials. Manufacturing two or more layers of the coalescing separator body from different material compositions makes it possible to combine the advantages of different materials with each other. For example, each ply or each layer of the coalescing separator body may have a different material composition.

The connection seams are manufactured by means of the technique of welding, for example, ultrasonic welding. In the ultrasonic welding process, a sonotrode melts the coalescing separator medium material so that the material fibers are fused to each other.

The overlappingly arranged regions of the coalescing separator medium layer elements connected to each other extend, beginning at the further coalescing separator body, into the drainage space, in other words in the direction toward the first coalescing separator body or downstream. In this context, the overlappingly arranged regions extend radially outwardly in the case of a gas flow being guided from the exterior to the interior or radially inwardly in the case of a gas flow being guided from the interior to the exterior. The connection seams thus project radially outwardly or radially inwardly. This has the advantage that the connection seams serve, for example, as a spacer to the first coalescing separator body for positioning the further coalescing separator body in the coalescing separator insert. In this way, it may be prevented that the further coalescing separator body, when being inserted into the coalescing separator insert, is caught or hooked at the first support tube and damaged in this way.

In this context, the designation toward the exterior refers to a direction which is arranged perpendicularly to the longitudinal axis of the coalescing separator insert and, beginning at the longitudinal axis of the coalescing separator insert, is oriented radially outwardly, i.e., toward the outer circumference of the coalescing separator insert. The designation toward the interior, on the other hand, refers to a direction which is arranged perpendicularly to the longitudinal axis of the coalescing separator insert and, beginning at the outer circumference of the coalescing separator insert, is oriented radially inwardly, i.e., toward the longitudinal axis or toward the center of the coalescing separator insert.

In order to enable centering of the further coalescing separator body in the coalescing separator insert, the respective elements of the coalescing separator medium layers are embodied symmetrically, for example mirror symmetrically, relative to each other, for example, arranged approximately symmetrically or substantially symmetrically around the further support tube.

In order to provide a stable connection, the connection seams are formed as continuous seams.

For providing a stable connection, the connection seams extend at least across two thirds of the length of the further coalescing separator body, for example substantially across the entire length of the further coalescing separator body.

Surprisingly, it was found that a sufficient shape stability of the further support tube may be achieved merely by a connection, for example, by an adhesive connection, of the further support tube to end disks arranged at the end faces. Aside from the fixation at the end disks, no further fixation is thus required. Because the coalescing separator medium layers of the further coalescing separator body are relatively lightweight, they transmit only little pressure to the further support tube. The further support tube may thus be produced simply, inexpensively, and stably in that a plate-type element, for example, a sheet metal including air openings, curved to a cylinder shape about its longitudinal axis, is connected at its end faces to the end disks by gluing. A further axially extending connection seam is not required. A multilayer construction of the post separator from several layers of relatively lightweight coalescing separator media enables thus a cost-efficient and efficiently manufacturable construction of the post separator support tube.

In a further embodiment of the present invention, the further coalescing separator body is designed such that an air permeability through the further coalescing separator body, for example, determined according to DIN EN ISO 9237, amounts to more than 300 liters per square meter second [l/m2s] and less than 4,500 liters per square meter second [l/m2s] at a pressure differential of 200 Pascal [Pa].

In comparison thereto, the air permeability of the first coalescing separator body, for example of the main separator, amounts to less than 400 l/m2s, for example, 5-300 l/m2s.

In connection therewith or as an alternative thereto, in an embodiment of the present invention the first coalescing separator medium may be arranged, for example wound, in multiple layers around the first support tube. The main separator may include several, for example, 3 to 20, coalescing separator medium layers, for example, glass fiber paper layers.

The further coalescing separator body is designed such that it includes a higher gas flow permeability, for example air permeability, than the respective layers of the first coalescing separator body. For example, a single layer of the main separator may include a lower permeability in comparison to the entire post separator, for example, half of the permeability of the post separator.

The present invention provides a coalescing separator insert as well as a coalescing separator with a post separator optimized with respect to separation, drainage, and manufacture.

Furthermore, the present invention concerns the use of at least one coalescing separator insert of the aforementioned kind and/or of a coalescing separator insert manufactured according to the method of the aforementioned kind and/or of a coalescing separator configured according to the aforementioned kind for air oil separation of air in a compressed air system or vacuum system that is supplied by, for example, an oil-lubricated connector element of a machine, for example, of a compressor or of a vacuum pump, wherein the compressed air system furthermore is configured to return the separated oil to the connector element.

Finally, the present invention concerns the use of at least one coalescing separator insert of the aforementioned kind and/or of a coalescing separator insert manufactured according to the method of the aforementioned kind and/or of a coalescing separator configured according to the aforementioned kind for air oil separation of crankcase gases of an internal combustion engine.

For example, the coalescing separator insert of the present invention may be used in any of the following non-exclusive applications:
in a spin-on coalescing separator or spin-on air oil separator,
in a compressor configured to compress air,
in a compressor configured for oil separation, wherein the oil is returned to the oil circuit, and
in applications with oils of the viscosity class VG32 and higher viscosity.

### BRIEF DESCRIPTION OF THE DRAWINGS

As already mentioned above, there are various possibilities for designing and further developing the teachings of the present invention in an advantageous manner. In this regard, on the one hand, reference is being had to the appended claims; on the other hand, further configurations, features, and advantages of the present invention will be explained in more detail in the following detailed description with the aid of the embodiments illustrated in FIGS. 1 to 5.

FIG. 1 shows in longitudinal section illustration a first embodiment of a coalescing separator according to the present invention, wherein a coalescing separator insert is manufactured according to a method of the present invention.

FIG. 2 shows in partially sectioned illustration the coalescing separator according to FIG. 1.

FIG. 3 shows a detail view of the coalescing separator of FIG. 1.

FIG. 4 shows in perspective illustration the further coalescing separator body of the coalescing separator insert of FIG. 1.

FIG. 5 shows in cross section illustration the further coalescing separator body of FIG. 4 in which the different coalescing separator medium layers and the outwardly extending connection seams are illustrated.

FIG. 6 shows a further embodiment of a coalescing separator insert which is manufactured according to a method of the present invention.

FIG. 7 shows in longitudinal section an illustration of the coalescing separator insert of FIG. 6.

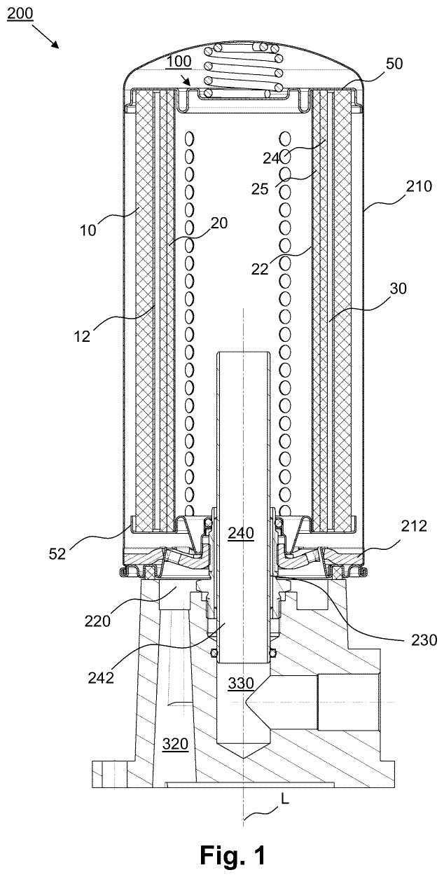

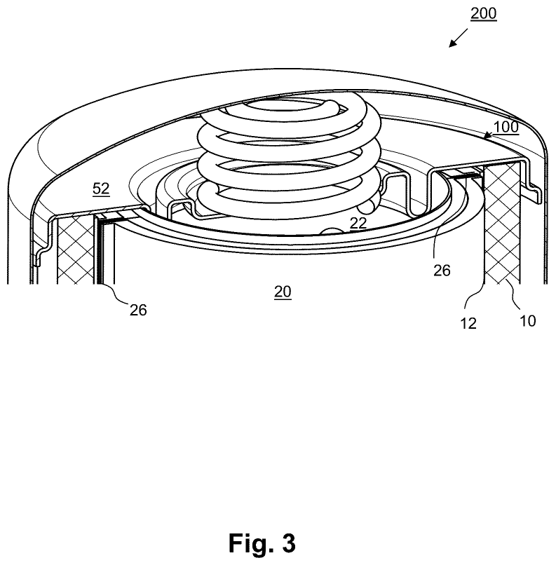

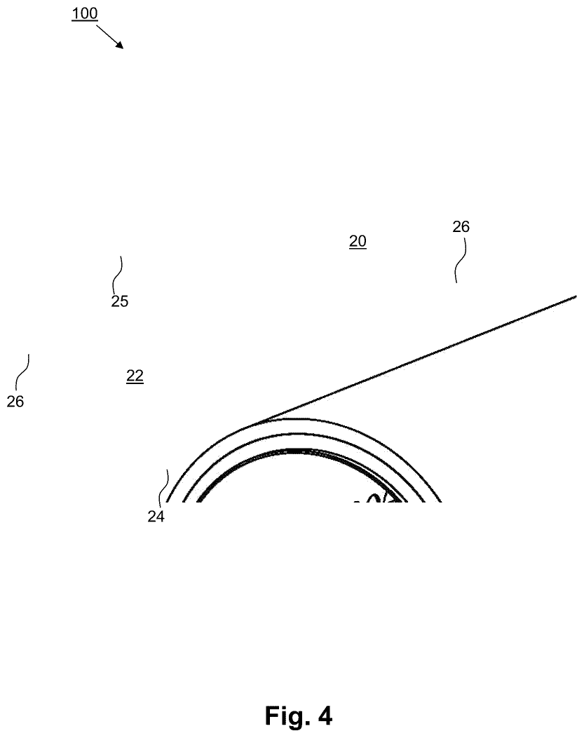

The same or similar embodiments, elements or features are provided with like reference characters in FIGS. 1 to 7.

### DETAILED DESCRIPTION

FIG. 1 shows in longitudinal section a coalescing separator, namely a so-called spin-on air oil separator 200 embodied for separating particles from a gas or from a gas mixture, for example for coalescing separation of aerosol, formed of liquid, from air. The liquid to be separated may be, for example, oil, fuel, hydraulic liquid or coolant.

The coalescing separator 200 comprises a cup-shaped pressure-stable housing body 210 in which an embodiment of a coalescing separator insert 100 configured according to the present invention is received.

A cover 212 serves for closing the open end face of the housing body 210. For supplying raw gas, the coalescing separator 200 comprises a raw gas inlet 220 which is connectable to a raw gas feed 320 of a connector element of a machine, for example, of a work machine, for example of a compressor, for example, of a compressed air compressor, for example, of a screw compressor. For discharging the purified clean gas, the coalescing separator 200 comprises a clean gas outlet 240 which is connectable to a clean gas feed 330 of the connector element.

In the spin-on air oil separator 200 illustrated in FIG. 1, the raw gas inlet 220 as well the clean gas outlet 240 are arranged at the cover 212, wherein the clean gas outlet 240 comprises a central cylinder-shaped cutout in which, for example, a tube-shaped nipple 242 may be arranged which axially extends through the cover 212. The nipple 242 is correlated with the connector element.

Furthermore, the cover 212 illustrated in FIG. 1 comprises at least one closure element that is movable by means of a rotational movement of the cover 212 between an open position, in which the nipple 242 is guided along a central axis L of the cup-shaped housing body 210 through the cover 212, and a closed position in which the nipple 242 is fixedly connected to the cover 212.

For covering its respective end faces, the hollow cylindrically embodied coalescing separator insert 100 illustrated in FIGS. 1 to 5 comprises a respective end disk 50, 52.

The embodiment of the coalescing separator insert 100 according to the present invention illustrated in FIGS. 1 to 5 is designed for example for use in smaller coalescing separators, for example in spin-on separators. Such gas flow coalescing separators 200 may comprise, for example, a gas flow rate of up to 8 standard cubic meters per minute at 7 bar operating pressure.

As an alternative to the embodiment illustrated in FIGS. 1 to 3, the coalescing separator could also be arranged in a compressed air pot (not illustrated). The compressed air pot coalescing separator differs from the spin-on air oil separator 200 for example in that the raw gas inlet 220 is arranged at the compressed air pot, the clean gas outlet 240 is arranged at the cover 212, and the end disk facing the cover 212 comprises a radially extending flange which is configured to arrange the coalescing separator insert 100 in the pressure-stable housing 210.

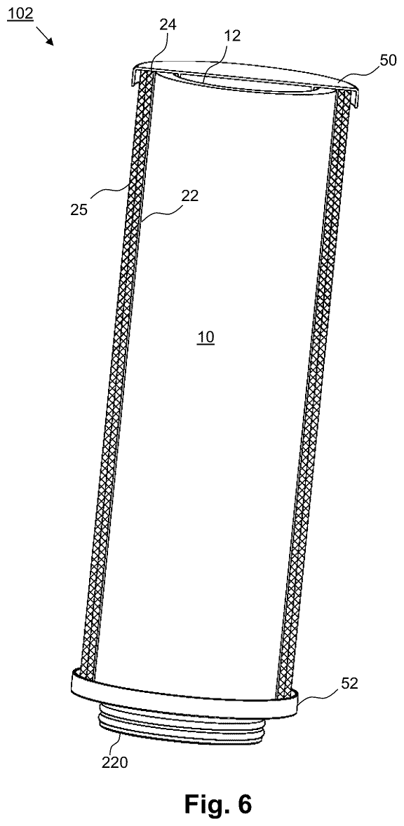

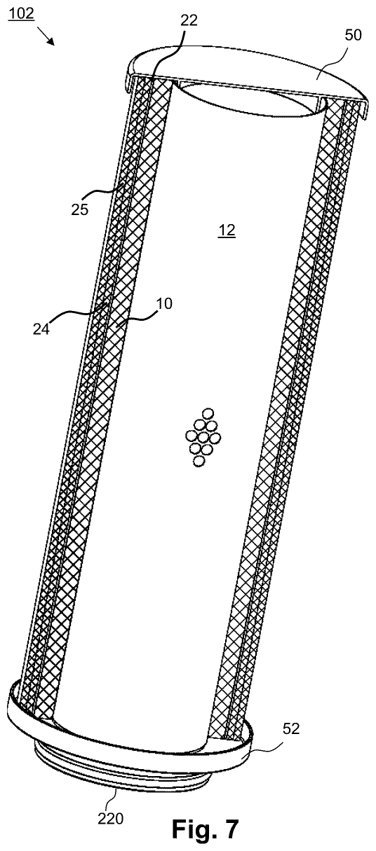

The coalescing separator insert 100 illustrated in FIGS. 1 to 5 serves for purifying air which flows therethrough from the exterior to the interior. The coalescing separating insert 102 illustrated in FIGS. 6 and 7 is configured to be flowed through from the interior to the exterior.

A main separator 10 of the coalescing separator insert 100 acting according to the coalescence principle is arranged around an air-permeable cylindrical supporting support tube 12, for example, wound in multiple layers around the support tube 12.

The main separator 10 may be made, for example, of glass fiber paper and comprise a significant proportion of micro glass fibers. For example, the main separator may comprise 5 to 20, for example, 15, individual layers. Each individual one of these layers may comprise, for example,
a weight of approximately 60 to 200 grams per square meter (g/m²) and/or
an air permeability of 5 l/m²s to 300 l/m²s, for example, of 30 l/m²s to 300 l/m²s, for example, determined according to DIN EN ISO 9237, at a pressure of 200 Pascal [Pa], and/or,
a thickness of approximately 0.4 mm to 2 mm, for example, measured at a pressure of 10 kPa in accordance with ISO 543.

A further coalescing separator body 20 acting according to the coalescence principle, namely a post separator, is arranged radially inside (compare FIGS. 1 to 5) or radially outside (compare FIGS. 6 and 7) of a first coalescing separator body 10, namely of a main separator 10. This post separator 20 is arranged concentrically or coaxially to the main separator 10 and may be spaced apart by a drainage space 30 from the main separator 10 for draining separated drops through an outlet for the separated liquid 230, for example, for separated oil. In addition to the function of draining the separated drops, the drainage space 30 has the function of preventing the coalescing separator media of the main separator 10 and of the post separator 20 to get caught when assembling the coalescing separator insert.

So that the post separator 20 withstands the pressure of the air flowing through, it is arranged around a further supporting support tube 22, a so-called post separator central tube.

The post separator 20 comprises at least two post separator layers 24, 25 sequentially arranged in a flow direction of the gas flow and arranged concentrically around the post separator support tube 22, respectively.

The post separator layers 24, 25 and the layer of the main separator 10 are illustrated in FIG. 1 in a serial arrangement in which the air flow extends from the exterior to the interior. As an alternative, the air flow may however also extend from the interior to the exterior in the present invention, wherein the post separator layers 24, 25 would then lie radially farther from the longitudinal axis L of the coalescing separator insert 100, 102 than the main separator 10.

The post separator layers 24, 25 are thus always located downstream of the main separator 10. This means that, for a gas flow guided from the exterior to the interior, the post separator layers 24, 25 are closer to the longitudinal axis L of the coalescing separator insert 100; 102 and, in the case of a gas flow guided from the interior to the exterior, the main separator 10 lies closer to the longitudinal axis L of the coalescing separator insert 100, 102.

Each post separator layer 24, 25 comprises in turn two material web elements 24a, 24b, 25a, 25b arranged oppositely positioned to each other. These material web elements 24a, 24b, 25a, 25b are arranged semi-circularly around the post separator support tube 22 in such a way that the post separator layer 24, 25 formed by them completely surrounds the post separator support tube 22.

In sum, the post separator 20 illustrated in the FIGS. 1 to 5 comprises four material webs 24a, 24b, 25a, 25b extending toward the central tube 22. Two material webs are placed from oppositely positioned sides around the central tube, respectively, and then welded and cut by two sonotrodes at regions that are approximately opposite each other. In the present invention, the layers of the post separator are thus connected, for example, welded, to each other at the further support tube 22.

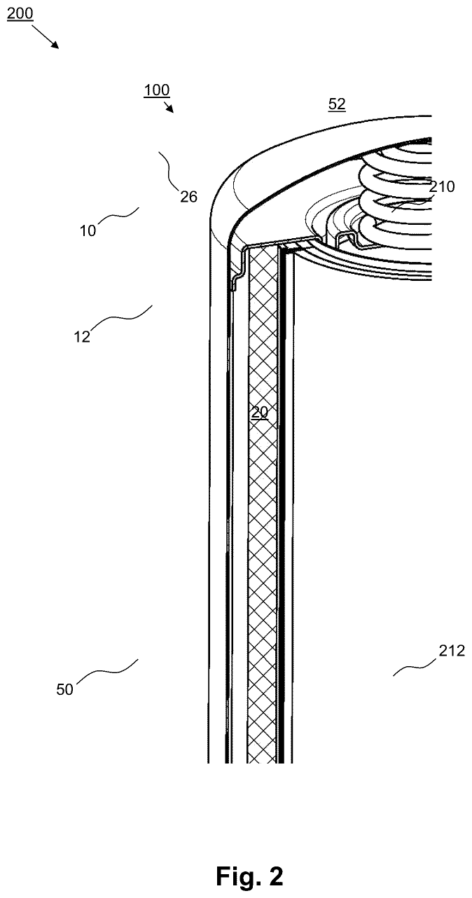

The approximately oppositely positioned seams 26 serve as spacers as well as for centering the post separator 20 in the air oil separation element 100 (compare FIG. 2). In contrast to known post separator layers held together by means of only one correspondingly thicker connection seam, the present post separator has the tendency to sit eccentrically in the coalescing separator insert.

The method of placing the material around the central tube and fusing it together at approximately oppositely positioned sides by means of sonotrodes and cutting it in the same working step may be integrated well in processes of manufacturing multilayer post separators. It is inexpensive, produces smaller seams in comparison to the single-layer prior art, so that more space for coalescing separator medium layers is provided.

The post separator 20 may comprise the following features, for example:
be constructed from nonwovens, for example, staple fiber nonwoven, spunbond, or meltblown;
be constructed from the materials polyester, polyamide, glass or mixtures thereof;
the air permeability of the entire post separator 20, for example, determined according to DIN EN ISO 9237, may be substantially higher, for example, by the factor two, than the air permeability of the individual coalescing layers of the main separator 10;
the thickness of the entire post separator 20, for example, determined according to DIN EN ISO 9073-2, may amount to at least 3 mm;
the thickness of the entire post separator 20 may be smaller than the thickness of the main separator 10; and
the air permeability of the entire post separator 20, for example, determined according to DIN EN ISO 9237, may amount to between 300 l/m²s and 4,500 l/m²s at 200 Pa.

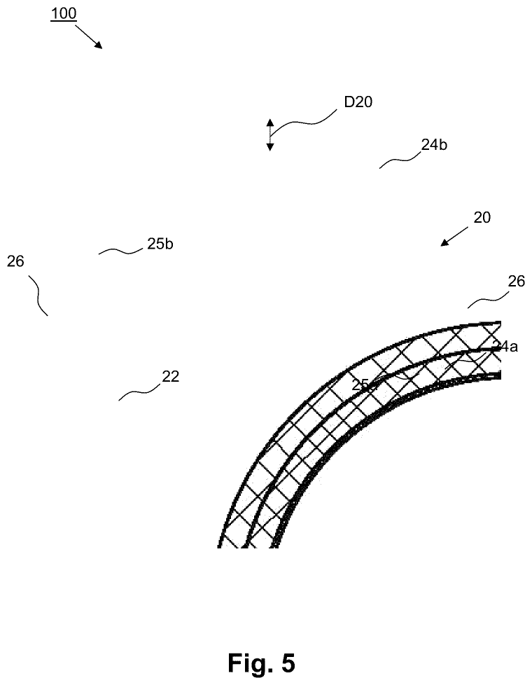

The multilayer arrangement of the post separator 20 provides the following advantages:
the degree of separation of the post separator 20 is significantly increased;
the drainage properties are not negatively affected which may be the case, for example, when using a single-layer post separator with a higher degree of separation;
at an overall greater radial thickness (see, D20 in FIG. 5) of the post separator 20, the drainage of the coalescing drops is increased; and
in comparison to the use of an individually adapted single-layer coalescing separator medium material, the multilayer arrangement of a conventional coalescing separator medium material is economically better and permits in addition the individual adaptation of the post separator 20 with respect to its degree of separation.

The further embodiment illustrated in the FIGS. 6 and 7 of a coalescing separator insert 102 differs from the coalescing separator insert 100 illustrated in FIGS. 1 to 5 in the flow direction of the gas flow. In the coalescing separator insert 102 illustrated in the FIGS. 6 and 7, the gas flow flows, in the position of use, from the interior to the exterior through the coalescing separator insert 102.

### REFERENCE CHARACTERS

10 first coalescing separator body for separation of liquid (drops) from a gas flow, for example, of oil (drops) from a (compressed) air flow, for example main separator medium or main separator
12 first support tube, for example main separator support tube, for example, first central tube configured to support the first coalescing separator body 10
20 further coalescing separator body, for example post separator medium body or post separator body, comprising the further coalescing separator medium in operative form, optionally tailored, stacked, wound, folded etc.
22 further support tube, for example post separator support tube, for example, further central tube configured to support the further coalescing separator body 20
24 first coalescing separator medium layer of the further coalescing separator body 20, for example first layer of the post separator 20
24a first element of the first coalescing separator medium layer 24, for example first material web element of the first coalescing separator medium layer 24
24b further element of the first coalescing separator medium layer 24, for example further material web element of the first coalescing separator medium layer 24
25 further coalescing separator medium layer of the further coalescing separator body 20, for example further layer of the post separator 20
25a first element of the further coalescing separator medium layer 25, for example first material web element of the further coalescing separator medium layer 25
25b further element of the further coalescing separator medium layer 25, for example further material web element of the further coalescing separator medium layer 25
26 connection seam, for example fixation seam, for example, region connected by the technique of welding and/or gluing and/or sewing, of the overlappingly arranged regions of the respective elements 24a, 24b, 25a, 25b of the coalescing separator medium layers 24, 25
30 drainage space arranged between first coalescing separator body 10 and the further coalescing separator body 20 for discharging oil separated by means of the first coalescing separator body 10
50 end disk, facing the cover 212, of the coalescing separator insert 100 of the coalescing separator 200
52 end disk, facing away from the cover 212, of the coalescing separator insert 100 of the coalescing separator 200
100 coalescing separator insert, for example air oil separation element, first embodiment; compare FIGS. 1 to 5
102 coalescing separator insert, further embodiment; compare FIGS. 6 and 7
200 coalescing separator, for example spin-on air oil separator
210 housing body of a pressure-stable housing of the coalescing separator 200
212 cover of the pressure-stable housing of the coalescing separator 200
220 raw gas inlet of the coalescing separator 200
230 outlet for the separated liquid, for example, for separated oil
240 clean gas outlet of the coalescing separator 200
242 clean gas outlet of the connector element, for example nipple
320 raw gas feed of the connector element
330 clean gas discharge of the connector element
D20 radial thickness of the further coalescing separator body 20
L longitudinal axis of the further coalescing separator body 20 or central axis of the housing body 210

That which is claimed is:

1. A coalescing separator insert for separating liquid from a gas flow that flows through the coalescing separator insert from an exterior to an interior of the coalescing separator insert or from the interior to the exterior of the coalescing separator insert, the coalescing separator insert comprising:
at least one first coalescing separator body comprising at least one first coalescing separator medium configured to separate liquid from the gas flow by coalescence;
an air-permeable, cylindrical first support tube configured to support the at least one first coalescing separator body, wherein the at least one first coalescing separator medium is arranged around the air-permeable, cylindrical first support tube;
at least one second coalescing separator body comprising at least one second coalescing separator medium configured to separate liquid from the gas flow by coalescence, wherein the at least one second coalescing separator medium is arranged downstream of the at least one first coalescing separator body in a flow direction of the gas flow and is arranged concentrically to the at least one first coalescing separator body;
wherein the at least one second coalescing separator medium is spaced apart radially from the at least one first coalescing separator body by a drainage space;
wherein the at least one second coalescing separator medium comprises at least two coalescing separator medium layers arranged concentrically in relation to the at least one first coalescing separator body.

2. The coalescing separator insert according to claim 1, further comprising a second support tube configured to support the at least one second coalescing separator body, wherein the at least two second coalescing separator medium layers are concentrically arranged around the second support tube.

3. The coalescing separator insert according to claim 1, wherein the at least two coalescing separator medium layers each comprise at least two separate coalescing separator medium layer elements, each comprising lateral end regions, wherein the at least two separate coalescing separator medium layer elements are arranged such that the lateral end regions of a first one of the at least two separate coalescing separator medium layer elements and the lateral end regions of a second one of the at least two separate coalescing separator medium layer elements overlap each other and are connected to each other by a connection seam, respectively, wherein the connection seams extend along a longitudinal axis of the at least one second coalescing separator body.

4. The coalescing separator insert according to claim 3, wherein the at least two separate coalescing separator medium layer elements are arranged around a second support tube configured to support the at least one second coalescing separator body.

5. The coalescing separator insert according to claim 3, wherein a first one and a second one of the at least two separate coalescing separator medium layer elements are substantially symmetrical relative to each other.

6. The coalescing separator insert according to claim 5, wherein the first one and the second one of the at least two separate coalescing separator medium layer elements are arranged approximately symmetrically around a second support tube configured to support the at least one second coalescing separator body.

7. The coalescing separator insert according to claim 3, wherein the connection seams, beginning at the at least one second coalescing separator body, extend into the drainage space in a direction toward the at least one first coalescing separator body.

8. The coalescing separator insert according to claim 7, wherein the connection seams extend radially outwardly when the gas flow is guided from the exterior to the interior of the coalescing separator insert or the connection seams extend radially inwardly when the gas flow is guided from the interior to the exterior of the coalescing separator insert.

9. The coalescing separator insert according to claim 3, wherein the first one and the second one of the at least two separate coalescing separator medium layer elements are arranged concentrically to the first coalescing separator body such that the respective coalescing separator medium layer formed by the first one and the second one of the at least two separate coalescing separator medium layer elements forms a closed cylinder wall surface.

10. The coalescing separator insert according to claim 3, further comprising a second support tube configured to support the at least one second coalescing separator body, wherein the at least two separate coalescing separator medium layer elements are arranged around the second support tube such that the respective coalescing separator medium layer completely surrounds the support tube.

11. The coalescing separator insert according to claim 1, further comprising a second support tube configured to support the at least one second coalescing separator body, wherein the coalescing separator insert is hollow cylindrical and comprises end faces, each end face covered by an end disk, wherein the second support tube is curved cylindrically around a longitudinal axis, wherein a shape of the second support tube is stabilized exclusively by a connection of the end disks to the end faces, respectively.

12. A coalescing separator comprising:
a coalescing separator insert according to claim 1;
a pressure-stable housing configured to receive the coalescing separator insert;
wherein the pressure-stable housing comprises a cup-shaped housing body and a cover configured to close an open end face of the cup-shaped housing body:
wherein the pressure stable housing further comprises a raw gas inlet, configured to supply raw gas to the coalescing separator, and a clean gas outlet, configured to discharge a clean gas.

13. The coalescing separator according to claim 12, wherein the raw gas inlet and the clean gas outlet are arranged at the cover, wherein the clean gas outlet comprises a central cylinder-shaped cutout configured to arrange a tubular nipple of a connector element therein so as to extend axially through the cover, wherein the cover comprises at least one closure element, wherein the closure element, by a rotational movement of the cover, is movable between an open position configured to guide the tubular nipple along a central axis of the cup-shaped housing body through the cover, and a closed position, wherein in the closed position the tubular nipple is fixedly connected to the cover.

14. A method of manufacturing a coalescing separator insert for cleaning a gas flow that flows through the coalescing separator insert from an exterior to an interior of the coalescing separator insert or from the interior to the exterior of the coalescing separator insert, the method comprising:
providing a first coalescing separator body by arranging at least one first coalescing separator medium around an air-permeable, cylindrical first support tube configured to support the first coalescing separator body;
providing a second coalescing separator body by arranging at least two coalescing separator medium layers of at least one second coalescing separator medium concentrically in relation to the first coalescing separator body, respectively;
arranging the second coalescing separator body concentrically in relation to the first coalescing separator body such that the second coalescing separator body is radially spaced apart by a drainage space from the first coalescing separator body.

15. The method according to claim 14, further comprising arranging the at least two coalescing separator medium layers concentrically around a cylindrical air-permeable second support tube configured to support the second coalescing separator body.

16. The method according to claim 14, further comprising:
for each one of the at least two coalescing separator medium layers, arranging at least two separate coalescing separator medium layer elements concentrically to the first coalescing separator body, wherein the at least two coalescing separator medium layer elements each comprise lateral end regions;
arranging the at least two separate coalescing separator medium layer elements of each one of the at least two coalescing separator medium layers such that the lateral end regions of a first one of the at least two separate coalescing separator medium layer elements and the lateral end regions of a second one of the at least two separate coalescing separator medium layer elements overlap each other;
connecting the overlapping lateral end regions to each other.

17. A method of separating oil from air of a compressed air system or of a vacuum system or from gases of a crankcase of an internal combustion engine, the method comprising using a coalescing separator insert, wherein the coalescing separator insert is a coalescing separator insert according to claim 1.

18. The method according to claim 17, further comprising returning the oil separated from the air to a connector element of the compressed air system or to a connector element of the vacuum system.

19. A method of separating oil from air of a compressed air system or of a vacuum system or from gases of a crankcase of an internal combustion engine, the method comprising using a coalescing separator, wherein the coalescing separator is a coalescing separator according to claim 12.

20. The method according to claim 19, further comprising returning the oil separated from the air to a connector element of the compressed air system or to a connector element of the vacuum system.
